(19) United States
(12) Patent Application Publication
(10) Pub. No.: US 2011/0021184 A1
(43) Pub. Date: Jan. 27, 2011

(54) METHOD OF MANAGING A DATA TRANSMISSION SERVICE

(75) Inventors: Yannick Bouguen, Marseille (FR); Jerome Pons, Paris (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: FRANCE TELECOM, Paris (FR)

(21) Appl. No.: 12/935,421

(22) PCT Filed: Mar. 30, 2009
(86) PCT No.: PCT/FR2009/050538

§ 371 Date: Sep. 29, 2010

(30) Foreign Application Priority Data
Mar. 31, 2008 (FR) 08/52094

(51) Int. Cl. H04M 3/00

(52) U.S. Cl. 455/419

(57) ABSTRACT

A method is provided for managing a service for transmitting data, between a communicating entity operating according to a first mode and a core network of a second mode, through an access node of an access network. The method includes beforehand a step of converting a request for activation of service in the first mode emitted by the communicating entity, into a request for activation of service in the second mode destined for the core network. The method further includes a step of selecting a radio support of the first mode between the access node and the communicating entity and establishing of a resource of the second mode between the access node and the core network, a step of sending a notification to the core network of an allocation of a radio access support of the second mode including a radio support and a resource of the second mode, and a step of sending a notification to the communicating entity of an allocation of a radio access support of the first mode including a radio support and a resource of the first mode.

### CROSS-REFERENCE TO RELATED APPLICATIONS

This application is a Section 371 National Stage Application of International Application No. PCT/FR2009/050538, filed Mar. 30, 2009 and published as WO 2009/125152 on Oct. 15, 2009, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of telecommunications and more precisely that of mobile radiocommunication networks.

More particularly, the disclosure relates to the management of a data transmission service between a communicating entity and a core network through an access network.

### BACKGROUND OF THE DISCLOSURE

The establishment of a transmission service depends in the first place on the nature of the data to be transmitted. As a result a distinction is made, for example, between the voice-over-circuit calls of which the corresponding data are of a circuit nature, and voice-over-IP calls of which the corresponding data are of a packet nature. For the uplink, that is to say for data originating from a communicating entity to be sent to a core network, the circuit-nature data are directed, via an access node of the access network, to a core network in circuit mode, and the packet-nature data are directed to a core network in packet mode. For the downlink, that is to say for data originating from a core network, the circuit-nature data or packet-nature data are directed from the core network respectively in circuit mode or in packet mode to the communicating entity, via an access node of the access network. The data then pass through different network entities, depending on their nature, after establishment of a radio access bearer, between the communicating entity and the core network in packet mode or in circuit mode. The interchanges between the communicating entity and the core network are managed by intermediate protocol layers according to the OSI model standardized by the ISO (International Standardization Organization).

The access node of the access network is for example a radio network controller (RNC) for a third-generation mobile radiocommunication network such as the UMTS, or else a base station notably in the context of using a mobile radiocommunication network architecture called flat.

A network architecture is called flat when a portion of the functions of the radio network controller is decentralized in the base stations in order to optimize the management of the packet services, for example as specified by the 3GPP (“3rd Generation Partnership Project) in the architecture of the LTE (Long Term Evolution) system.

The radio access bearer established between the communicating entity and the core network in packet mode or in circuit mode consists of a radio bearer (RB) between the communicating entity and the access node, and a terrestrial resource RT between the access node and the core network in packet mode or in circuit mode. The radio access bearer and the terrestrial resource are managed by low layer protocols and defined according to the nature of the data to be transmitted.

Therefore, to a voice-over-circuit service activation request there corresponds an allocation of a pair [circuit radio bearer, circuit terrestrial resource], and to a voice-over-IP service activation request there corresponds an allocation of a pair [packet radio bearer, packet terrestrial resource].

However, the evolution of the mobile radio network architectures, controlled by an increasing demand for packet service, generates additional delays in establishing circuit service requests. These additional delays are induced by redirections of the service request in architectures optimized for packet transmissions. Specifically, in the case of a flat architecture, the functional elements of a radio network controller transferred to the base station relate only to the management of packet services. Circuit service requests are then redirected to another radio network controller connected to the circuit core network.

Moreover, since the circuit-nature data, for example for a voice-over-circuit service, are managed by protocol layers between the core network and the access nodes, the operators are obliged to maintain and dimension all of the equipment of the access network and of the core network in circuit mode in order to satisfy circuit service requests. Additionally, the operators cannot provide the communicating entity with the core network capacities in packet mode capable of delivering a voice-over-IP call when the initial request relates to a circuit service request.

In the particular case of an access node that is not connected to the core network in circuit mode, a circuit service such as a voice-over-circuit service cannot be established. Therefore, the use of an architecture that is in packet mode only is not compatible with communicating entities supporting the circuit mode and requesting activation of a circuit service. The communicating entities are for example mobile terminals or any equipment comprising a communicating card such as for example a personal digital assistant.

There is therefore a need for a method for managing a data transmission service making it possible to support a service activation request in a first mode, without making use of the equipment of the core network corresponding to this first mode. This method must also be capable of being used for different mobile radiocommunication network architectures, for example in a centralized architecture or a flat architecture, without modification of the communicating entities.

### SUMMARY

An embodiment of the invention proposes a method for managing a data transmission service, between a communicating entity operating according to a first mode and a core network of a second mode, through an access node of an access network. The method first comprises the steps of:

conversion of a service activation request in the first mode transmitted by the communicating entity, into a service activation request in the second mode to be sent to the core network,

selection of a radio bearer of the first mode between the access node and the communicating entity, and establishment of a resource of the second mode between the access node and the core network,

notification to be sent to the core network of an allocation of a radio access bearer of the second mode comprising a radio bearer and a resource of the second mode,

notification to be sent to the communicating entity of an allocation of a radio access bearer of the first mode comprising a radio bearer and a resource of the first mode.

This method therefore makes it possible to make no demands of a core network of the first mode. Moreover, the service is seen by the communicating entity as a service of the first mode according to its request, and seen as a service of the second mode by the core network of a second mode whose services are requested by the access node. Therefore, no modification of the communicating entity is required, and the latter can benefit from the resources of this core network of the second mode.

The method can also interact with communicating entities supporting both modes or only one transmission mode, in an architecture with or without a core network of the first mode.

The method comprises subsequent steps of

conversion of the data as a function of the first and second modes,

transmission of the converted data between the communicating entity and the core network.

Therefore no modification of the communicating entity is required, the data conversion being carried out by the access node. The method therefore makes it possible to use an architecture with no core network of the first mode, while ensuring compatibility of the communicating entities of the first mode. Moreover, the existing communicating entities supporting both modes or simply the first mode are compatible with the use of architectures optimized for data associated with a service of the second mode, for example for flat architectures. No redirection of the service request is made and therefore no additional delay in the activation of the service is generated.

The data transmitted by the communicating entity in the form of frames of the first mode are converted in the form of frames of the second mode by the access node, by code conversion of the data of the frames of the first mode and insertion of a header into the frames resulting from the code conversion. Similarly, the data transmitted by the core network in the form of frames of the second mode are converted in the form of frames of the first mode by the access node, by deletion in said frames of the second mode of a header and code conversion of the data.

The notification to be sent to the communicating entity of an allocation of a radio access bearer of the first mode comprises a conversion of a notification message originating from the core network.

Therefore, no additional signaling is necessary either between the access node and the core network or between the access node and the communicating entity.

The conversion of the service activation request comprises a translation of a quality of service level in the first mode into a quality of service level in the second mode.

Therefore, the quality of service at the time of the service activation request for transmission of data by the communicating entity is ensured without interchange of additional signaling between the communicating entity and the core network of a second mode. The change of mode in the access node does not adversely affect the quality of service for the communicating entity.

The selection of a radio bearer, during the service activation step, is determined by at least one of the following items of information:
indications of capabilities of the communicating entity delivered to the access node,
indications of availability of the radio media of the first mode,
indications of quality of the radio media of the first mode,
indications of the type of service requested by the communicating entity.

Therefore, the access node can select a radio bearer suitable for the capabilities of the communicating entity, or else as a function of the quality of the radio link or links corresponding to the radio bearer between the communicating entity and the access node.

An embodiment of the invention also relates to a device for managing a service for transmission of data between a communicating entity operating according to a first mode and a core network of a second mode through an access node of an access network. The device comprises:
means of conversion of a service activation request in said first mode transmitted by the communicating entity into a service activation request in the second mode to be sent to the core network,
means for selecting a radio bearer of the first mode between said access node and the communicating entity and for establishment of a resource of the second mode between said access node and the core network,
means of notification to be sent to the core network of an allocation of a radio access bearer of the second mode comprising a radio bearer and a resource of the second mode,
means of notification to be sent to the communicating entity of an allocation of a radio access bearer of the first mode comprising a radio bearer and a resource of the first mode.

The device also comprises means (CONV_FL21_CONV_FL12) for converting the data in first and second modes.

An embodiment of the invention also relates to an access node of a radio access network suitable for being connected to a core network comprising a device according to the invention.

The device and the access node have advantages similar to those described above.

### BRIEF DESCRIPTION OF THE DRAWINGS

Other features and advantages will appear more clearly on reading the following description of a particular embodiment of the method for managing a data transmission service and associated access nodes, given as illustrative and nonlimiting examples, and the appended drawings in which:

FIG. 1 represents a centralized architecture of a mobile radiocommunication network,

FIG. 2 represents an example of a flat architecture of a mobile radiocommunication network,

FIG. 3 represents schematically the elements constituting a data transmission service between a communicating entity and a core network,

FIG. 4 represents the steps for managing a transmission service according to an embodiment of the invention,

FIG. 5 represents schematically an access node according to an embodiment of the invention.

### DETAILED DESCRIPTION OF ILLUSTRATIVE EMBODIMENTS

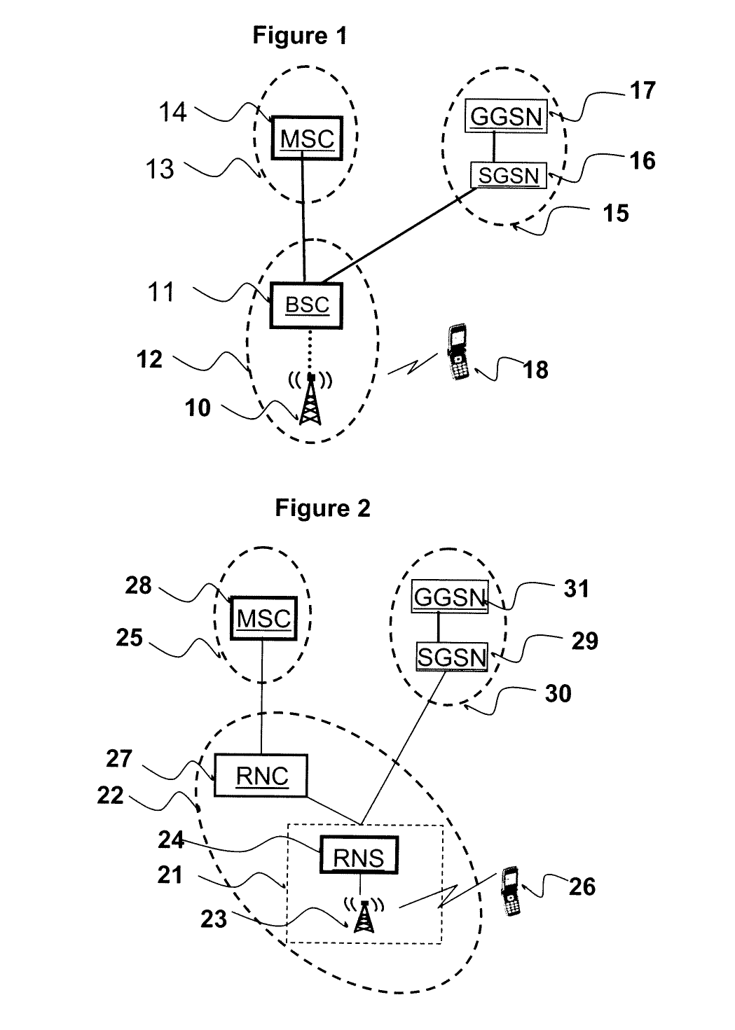

FIG. 1 represents an example of a centralized telecommunication network architecture used for mobile radiocommunication networks, for example of the GSM/GPRS or UMTS GERAN (for “GSM Edge Radio Access Network”) or else UMTS UTRAN (for “UMTS Terrestrial Radio Access Network”) type.

In this architecture, the access nodes are base stations 10 controlled by radio network controllers 11. The radio network controllers are for example items of equipment called BSC (for “Base Station Controller”) for access networks 12 of the GSM/GPRS or UMTS GERAN type, or items of equipment called RNC (for “Radio Network Controller”) for access networks of the UMTS UTRAN type.

The base station controllers are connected to a core network in circuit mode 13 by means of a mobile switching center (MSC) 14 or of an MSC and a media gateway (MGW), and to a packet core network 15 by means of a session management node SGSN 16 (for “Serving GPRS Support Node”). This session management node is connected to a data network interconnection gateway GGSN 17 (for “Gateway GPRS Support Node”).

After selection of a mobile radiocommunication network offering a circuit service, a communicating entity 18 sends a circuit service activation request to the core network in circuit mode 13 without the access node 10 analyzing the message associated with the request. The access node 10 therefore simply transfers the request to the core network in circuit mode. The circuit service can be carried out on activation on the one hand of a radio bearer between the communicating entity and the access node, and, on the other hand, of a terrestrial resource between the access node and the core network in circuit mode. The pair [radio bearer, terrestrial resource] is established at the request of the core network in circuit mode. The circuit service is for example a voice-over-circuit call, a videophone over circuit call or else a fax over circuit.

In the case of a flat architecture, as shown in FIG. 2, a set of functionalities of the work controller are transferred into the base station. These are for example architectures of the HSPA evolution (for “High Speed Packet Access Evolution”), LTE/SAE (for “Long Term Evolution/System Architecture Evolution”) or else WiMax type. In such architectures, the access nodes 21 of an access network 22, also called “Node B+” in the case of the HSPA evolution, comprise a base station 23 and an RNS controller 24 comprising a portion of the functionalities of a radio network controller.

In such architectures, the circuit services and the connections to the core network in circuit mode 25 are not supported by the RNS controller. The circuit service requests of a communicating entity 26 are then redirected to a radio network controller RNC 27 supporting the circuit mode and connected to a mobile switching center 28 of the core network in circuit mode. The packet services are processed by the RNS controller 24 which is connected to a session management node SGSN 29 of the core network in packet mode 30. The session management node 29 is connected to a data network interconnection gateway GGSN 31.

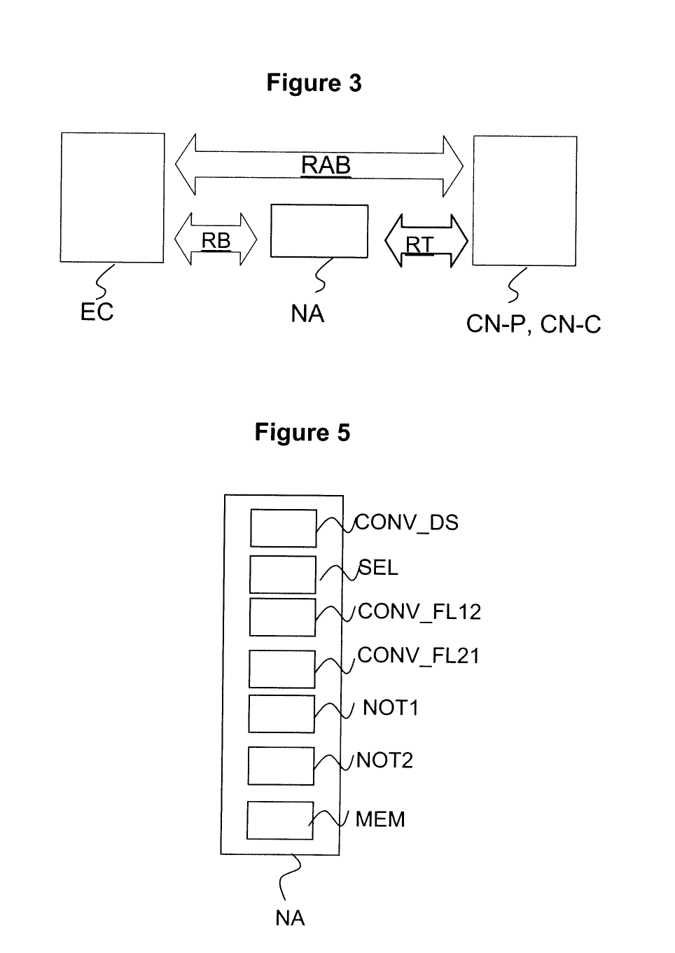

With reference to FIG. 3, the activation of a data transmission service relies on the allocation of a radio access bearer (RAB) between the communicating entity EC and the core network in circuit mode CN-C or the core network in packet mode CN-P, both in a centralized architecture and in a flat architecture. The allocation of a radio access bearer RAB corresponds to the allocation of one or more data streams on the radio interface connecting the communicating entity and the access node. A data frame generated by a codec of the AMR (for “Adaptive Multi Rate”) type in the communicating entity can, for example, be transported by three streams, each stream having a different data protection level on the radio interface.

The radio access bearer RAB, established between the communicating entity EC and the core network in packet mode or in circuit mode, consists of a radio bearer RB between the communicating entity EC and the access node NA, and a terrestrial resource RT between the access node NA and the core network in packet mode or the core network in circuit mode. The resource is for example a support called an “Iu Support” in the case of a mobile radiocommunication network of the UMTS type, version 99 and later versions.

The OSI communication model defines the data transmission service management by means of seven superposed protocol layers: the physical layer (layer 1), the data link layer (layer 2), the network layer (layer 3), the transport layer (layer 4), the session layer (layer 5), the presentation layer (layer 6) and the application layer (layer 7).

The radio access bearer RAB, defined between the communicating entity and the core network in packet mode or the core network in circuit mode, is managed by layers of intermediate protocols according to this model, typically the layers 4 and 5, and depending on the nature of the data to be transmitted.

The radio bearer RB and the resource RT are managed by low layer protocols, typically layers 1 to 3, and defined depending on the nature of the data to be transmitted.

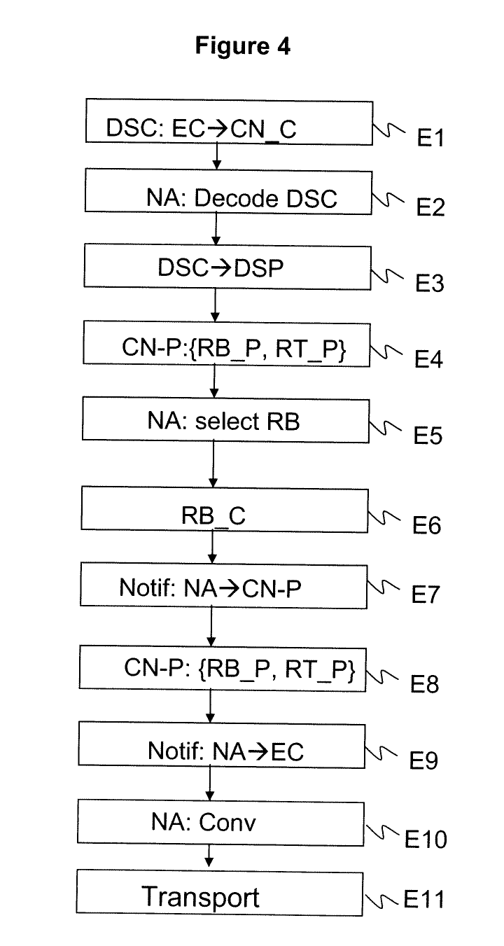

A particular example of application of the method for managing a data transmission service is now described with reference to FIG. 4. For the purposes of clarity, the method is described for a circuit service request corresponding to a first transmission mode, for example for a voice-over-circuit service. The second transmission mode corresponds in this case to a transmission in packet mode.

To establish a circuit service, a communicating entity first selects a mobile radiocommunication network offering such a service, for example a radiocommunication network of the GSM or UMTS type. This selection is made after the communicating entity is attached to an access node and a core network. The attachment is for example made according to the specifications of the GSM/GPRS or specifications of the UMTS from version 99 onwards for GERAN and UTRAN access.

The request to activate a circuit service, for example a voice-over-circuit call, can be made on the initiative of the communicating entity and the call is then called outgoing. The activation request may also be made on receipt of a message originating from a remote communicating entity desiring the activation of a circuit service such as a voice-over-circuit call. The call is then called incoming. An embodiment of the invention applies without distinction to these two cases.

In step E1, the communicating entity transmits a circuit service request DSC to be sent to the core network in circuit mode CN-C.

As a variant, this service request is supplemented by a set of information on the capability of the communicating entity such as, for example and in a nonlimiting manner, the various codecs supported, the authorized radio bearers, the layer 1 to 7 protocols recognized, the radio access technologies supported.

In step E2, the service request is decoded by the access node NA. For this, the access node analyzes the content of the signaling message(s) generated by the communicating entity. For example, the access node analyzes one of the NAS (for “Non Access Stratum”) layers supporting the unencrypted signaling messages between the communicating entity and the core network. The access node stores all or some of the message(s) associated with the service request, for example the type of service requested by the communicating entity.

In step E3, the access node converts the circuit service request DSC into a packet service request DSP to be sent to a core network in packet mode CN-P. For this, the access node translates the quality of service requirements in circuit mode indicated in the service request DSC into quality of service requirements in packet mode. This translation is made for example by reading a configurable mapping table stored in or accessible to the access node.

This mapping table may furthermore be given as a function of the capabilities of the communicating entities, for example by considering the features of their codecs. The service request DSP is then transmitted to the packet core network.

In step E4, on receipt of the packet service request DSP, the core network in packet mode CN-P asks the access node to establish a packet radio bearer RB_P between the access node and the communicating entity. It also requests the establishment of a packet resource RT_P. The access node establishes the packet resource. The access node is then the termination of protocols for example of layers 3 to 6 according to the OSI model, such as, for illustration purposes, the IP, UDP or RTP protocols.

In this case, the data interconnection gateway GGSN allocates one or more packet communication contexts PDP1, PDP2, . . . PDPn (“PDP context”). The establishment of the communication contexts may be carried out by emulation in the access node of a signaling protocol layer, for example by emulation of the SM (for “Session Management”) layer. The communication context PDP1, called the primary context, is dedicated to the transmission of the data of the signaling plane associated with a packet service, for example for signaling of the SIP (for “Session Initiation Protocol”) type. The context PDP2, called the secondary context, is dedicated to the transmission of data of the user plane associated with a packet service, for example in the form of an RTP (for “Real Time Transport Protocol”) stream of a voice-over-packet service.

The core network in packet mode also allocates one or more IP addresses to the access node as part of establishing the communication contexts.

The access node may also store information of layers 3 to 7 such as the IP address or addresses assigned to the access node by the core network in packet mode.

In step E5, the access node selects a circuit radio bearer RB_C between the access node and the communicating entity.

This selection may be made on information on load or quality of the access network, which information can be accessed by the access node, for example by considering the radio quality of the various radio links corresponding to the radio bearers.

This selection may also consider information on the capability of the communicating entity, this information being delivered by the latter to the access node at the time of the service request, or previously stored in the access node at the time, for example, of a procedure for attaching the communicating entity to the access network and to the core network.

This selection may also consider indications of authorization of the radio bearers, this information being delivered by the communicating entity to the access node at the time of the service request in step E1.

This selection may also consider indications concerning the type of service requested by the communicating entity, these indications being stored at the time of step E2.

During step E6, the access node asks the communicating entity to establish the selected circuit radio bearer RB_C, for example according to the specifications of the various UMTS versions.

In step E7, the access node notifies the core network in packet mode that a packet radio bearer RB_P and a packet resource RT_P are available. The packet core network then assumes that a packet radio bearer has indeed been established although in reality a circuit radio bearer has been established.

In step E8, the packet core network notifies the communicating entity that the packet radio access bearer RAB_P is established. This notification message which passes through the access node complies for example with the specifications of the various versions of UMTS.

In step E9, the access node converts the content of the notification message transmitted by the core network during step E8.

For example, in the case of a mobile radiocommunication network of the UMTS type, the signaling messages SIP originating from the core network, including the notification messages, are converted into signaling messages according to the call control (CC) protocol.

The converted message is therefore a message of notification of the establishment of a circuit radio access bearer RAB_C. It is then transmitted to the communicating entity.

The circuit radio bearer RB_C having been activated between the access node and the communicating entity, and the packet terrestrial resource RT_P having been activated between the access node and the core network in packet mode, the data transmission can begin.

In step E10, the access node then converts the data.

The transmission can be two-way and the data are converted as a function of the transmission direction.

The data transmitted by the communicating entity have a circuit frame format generated by a codec operating in circuit mode. These circuit frames consist of a preamble and a body of frames. For example, an AMR codec operating in circuit mode generates circuit frames of 31 bytes every 20 milliseconds. The circuit frame is transported by one or more streams corresponding to the circuit radio access bearer notified by the access node.

In the particular case of several substreams, the access node is capable of reconstituting the circuit frame from the received substreams.

The circuit frames are converted into packet frames by code conversion. The code conversion depends on the format of the frames transmitted by the codec of the communicating entity. The type of codec is for example an item of information amongst all the items of capability information of the terminal delivered during the step E1, or else previously stored in the access node during, for example, a procedure of attachment of the communicating entity.

In the particular case of the code conversion of a circuit frame of the AMR type to a packet frame of the AMR type, only the preamble is converted in order to obtain packet frames of 32 bytes.

In all cases, a header corresponding to the protocol interchanges in packet mode is then added to the packet frame in order to form a transport frame for packet mode. For example, the header added corresponds to an IP/UDP/RTP header determined based on the information of layers 3 to 7 stored, for example, by the access node during step E4.

In step E11, the packet transport frames are transported to the core network in packet mode.

The data transmitted by the packet core network have a transport frame format in packet mode. A transport frame in packet mode comprises, for example, an IP/UDP/RTP header. The transport frames also comprise a packet frame generated by a codec and consisting of a preamble and a body of frames. For example, an AMR codec operating in packet mode generates packet frames of 32 bytes every 20 milliseconds.

The access node, during the conversion of the data originating from the core network, thus deletes the header of the packet transport frame.

The header may also be stored by the access node for the purpose, for example, of adding it in the opposite transmission direction.

Moreover, the packet frames are converted into circuit frames by code conversion of the packet frame. The code conversion depends on the type of codec of the communicating entity. The type of codec is, for example, an item of information amongst all of the items of capability information of the terminal delivered during step E1, or else previously stored in the access node during, for example, a procedure of attachment of the communicating entity.

In the particular case of the code conversion of a packet frame of the AMR type into a circuit frame of the AMR type, only the preamble is converted in order to obtain circuit frames of 31 bytes.

In step E11, the circuit frames are transported to the communicating entity by one or more streams corresponding to the circuit radio bearer.

The device for managing a data transmission service according to an embodiment of the invention can be applied in an access node of a mobile radiocommunication network. An access node is for example a radio network controller in a centralized architecture or else a base station having a portion of the functionalities of a radio network controller in a flat architecture.

An access node according to an embodiment of the invention is now described with reference to FIG. 5 in which, for the purposes of clarity, only the elements of the access node associated with an embodiment of the invention are shown. The access nodes also comprise a central control unit, not shown, to which the included means are connected, and which is designed to control the operation of these means.

The access node comprises:

conversion means CONV_DS arranged to convert a data transmission service activation request in a first mode transmitted by a communicating entity to be sent to a core network of the second mode, into a data transmission service request in a second mode,

means SEL for selecting a radio bearer of the first mode between the access node and the communicating entity and for establishing a resource of the second mode between said access node and the core network,

notification means NOT1 arranged to notify the core network of an allocation of a radio access bearer of the second mode comprising a radio bearer and a resource of the second mode,

notification means NOT2 arranged to notify the communicating entity of an allocation of a radio access bearer comprising a radio bearer and a resource of the first mode.

The access node also comprises:
conversion means CONV_FL12 arranged to convert data of a first mode into a data stream of the second mode,
conversion means CONV_FL21 arranged to convert data of a second mode into a data stream of the first mode.

The access node also comprises a memory MEM suitable for storing information interchanged between a communicating entity and a core network and passing into the access node.

An embodiment of the invention described here relates to a device for managing a data transmission service. Consequently, an embodiment of the invention also applies to a computer program, notably a computer program on or in an information storage medium, suitable for applying an embodiment of the invention. This program can use any programming language and be in the form of source code, object code or intermediate code between source code and object code such as in a partially compiled form, or in any other desirable form for implementing the process according to an embodiment of the invention.

The information storage medium may be any entity or device capable of storing the program. For example, the medium may comprise a storage means or storage medium on which the computer program according to an embodiment of the invention is stored, such as, but not limited to, an ROM, for example a CD ROM or a microelectronic circuit ROM, or else a USB key, or a magnetic storage means, for example a diskette (floppy disk) or a hard disk, or a smart card.

Although the present disclosure has been described with reference to one or more examples, workers skilled in the art will recognize that changes may be made in form and detail without departing from the scope of the disclosure and/or the appended claims.

1. A method for managing a data transmission service, between a communicating entity operating according to a first mode and a core network of a second mode, through an access node of an access network, the method comprising:
converting a service activation request in said first mode transmitted by the communicating entity, into a service activation request in the second mode to be sent to the core network,
selecting a radio bearer of the first mode between said access node and the communicating entity, and establishment of a resource of the second mode between said access node and the core network,
sending a notification to the core network of an allocation of a radio access bearer of the second mode comprising a radio bearer and a resource of the second mode, and
sending a notification to the communicating entity of an allocation of a radio access bearer of the first mode comprising a radio bearer and a resource of the first mode.

2. The management method as claimed in claim 1, comprising subsequent steps of:
converting data as a function of the first and second modes,
transmitting the converted data between the communicating entity and the core network.

3. The method as claimed in claim 2, in which the data transmitted by the communicating entity in the form of frames of the first mode are converted in the form of frames of the second mode by the access node, by code conversion of the data of said frames of the first mode and insertion of a header into the frames resulting from the code conversion.

4. The method as claimed in claim 2, in which the data transmitted by the core network in the form of frames of the second mode are converted in the form of frames of the first mode by the access node, by deletion in said frames of the second mode of a header and code conversion of the data.

5. The method as claimed in claim 1, wherein sending a notification to the communicating entity of an allocation of a radio access bearer of the first mode comprises a conversion of a notification message originating from the core network.

6. The method as claimed in claim 1, wherein converting the service activation request comprises a translation of a quality of service level in the first mode into a quality of service level in the second mode.

7. The method as claimed in claim 1, wherein selecting a radio bearer is determined by at least one of the following items of information:
indications of capabilities of the communicating entity delivered to the access node,
indications of availability of radio media of the first mode,
indications of quality of radio media of the first mode, or
indications of a type of service requested by the communicating entity.

8. A device for managing a service for transmission of data between a communicating entity operating according to a first mode and a core network of a second mode through an access node of an access network, wherein the device comprises
means for converting a service activation request in said first mode transmitted by the communicating entity into a service activation request in the second mode to be sent to the core network,
means for selecting a radio bearer of the first mode between said access node and the communicating entity and for establishment of a resource of the second mode between said access node and the core network,
means for sending a notification to the core network of an allocation of a radio access bearer of the second mode comprising a radio bearer and a resource of the second mode,
means for sending a notification to the communicating entity of an allocation of a radio access bearer of the first mode comprising a radio bearer and a resource of the first mode.

9. The management device as claimed in claim 8, comprising means for converting the data in first and second modes.

10. An access node of a radio access network suitable for being connected to a core network, said access node comprising a device as claimed in claim 8.

11. A non-transient information storage medium comprising a computer program stored thereon for an access node, the program comprising software instructions for commanding the access node to perform a method for managing a data transmission service, between a communicating entity operating according to a first mode and a core network of a second mode, through the access node, wherein the method comprises:
converting a service activation request in said first mode transmitted by the communicating entity, into a service activation request in the second mode to be sent to the core network,
selecting a radio bearer of the first mode between said access node and the communicating entity, and establishment of a resource of the second mode between said access node and the core network,
sending a notification to the core network of an allocation of a radio access bearer of the second mode comprising a radio bearer and a resource of the second mode, and
sending a notification to the communicating entity of an allocation of a radio access bearer of the first mode comprising a radio bearer and a resource of the first mode.
